(19) United States
(12) Patent Application Publication
(10) Pub. No.: US 2010/0023530 A1
(43) Pub. Date: Jan. 28, 2010

(54) METHOD AND APPARATUS FOR PROVIDING RICH MEDIA SERVICE

(75) Inventors: Seo-Young HWANG, Suwon-si (KR); Jae-Yeon SONG, Seoul (KR); Kyung-Mo PARK, Seoul (KR); Kook-Heui LEE, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO.,LTD, Suwon-si (KR)

(21) Appl. No.: 12/504,303

(22) Filed: Jul. 16, 2009

(30) Foreign Application Priority Data
Jul. 16, 2008 (KR) 10-2008-0069342
Oct. 8, 2008 (KR) 10-2008-0098864

(51) Int. Cl. G06F 17/30

(52) U.S. Cl. 707/10; 707/E17.01

(57) ABSTRACT

A method is provided for providing a received rich media service by a terminal. The method includes receiving and decoding service content, searching for reference information using representation information of the reference information in the received service content, and composing the received service content in a form that can be provided to a user, using the searched reference information. The composed service content is then output to the user through a user interface.

### PRIORITY

This application claims priority under 35 U.S.C. §119(a) to a Korean Patent Application filed in the Korean Intellectual Property Office on Jul. 16, 2008 and assigned Serial No. 10-2008-0069342, and a Korean Patent Application filed in the Korean Intellectual Property Office on Oct. 8, 2008 and assigned Serial No. 10-2008-0098864, the entire disclosures of which are incorporated herein by reference.

### BACKGROUND OF THE INVENTION

1. Field of the Invention

The present invention relates generally to a method and apparatus for providing a rich media service, and more particularly, to a method and apparatus for providing a rich media service referring to other services, files, information and/or data associated with rich media content.

2. Description of the Related Art

The broadcasting-communication market requires continuous development of new services through recombination or integration of the existing technologies. To meet these requirements, communication and broadcasting technologies are developing to enable a rich media service that provides several media such as texts, audio, video, fonts, images and graphics in a fixed form, on portable terminals (hereinafter “terminals”) such as mobile phones and Personal Digital Assistants (PDAs). For example, international standards currently offering the rich media service include Lightweight Application Scene Representation (LASeR), Binary Format for Scene (BIFS), etc.

The rich media service provides richer user services through scene description, free expression of various multimedia elements such as video, audio, images, fonts, texts, metadata and scripts, and interaction with users.

FIG. 1 illustrates an operation of a terminal receiving a rich media service according to the prior art.

Referring to FIG. 1, a terminal receives service content in step 110, and decodes the received service content in step 120. In step 130, the terminal performs a service composition operation, i.e., composes the decoded service content in a form that can be provided to a user. The service composition operation may include checking and executing commands and/or handling events. In step 140, the terminal outputs the composed service through a user interface supporting video and/or audio, in order to provide the composed service to the user.

LASeR content, an example of the rich media service content, can be expressed in the syntax of Table 1 below.

TABLE 1

```
<NewScene>
    <svg>
    ...
    </svg>
</NewScene>
```

In accordance with Table 1, the terminal composes and displays a scene (<svg> . . . </svg>) included in a command (<lsru:NewScene>) during every execution of the command.

The current technology trend enables a network model like Digital Video Broadcasting (DVB)-Convergence of Broadcasting and Mobile Service (CBMS) or Internet Protocol Television (IPTV), in which several kinds of terminals are connected to one network with integration of respective networks. In a business model where a single integrated service provider runs a network that is wire/wireless-integrated in wire IPTV, the same service can be offered to all terminals irrespective of their types.

For example, in case of a broadcast service, one broadcast stream can be simultaneously transmitted to terminals having different display sizes, performances, and characteristics. That is, when the same service is provided to various kinds of terminals, the same broadcast stream will be transmitted to the terminals, including a digital TV and a portable terminal. In this context, technologies are proposed that provide an adaptive rich media service that is agreeable with various situations of each terminal and user, which are associated with the service.

In order to provide such an existing adaptive service, the service provider should find all situations of respective terminals and users, and provide services according thereto. However, it is not actually possible for the service provider to predict all situations of the terminals and users, and even though the service configuration is the same, the form and result of a service that should be provided are variable according to the service situations and conditions, and it is not easy to support the variation. For example, when it is desired to provide a service capable of changing a background color of a service scene depending on preference of a user, the service provider should figure out all colors preferred by each of users and, according thereto, provide a service in which the preferred color of each user is applied or applicable as a background color of the service scene, but this is not easy.

Meanwhile, with the development of information representation and description, utilization and consumption of various media elements and also more various information, including data, resources, files, application programs and services, are possible. For example, the existing information about an image merely includes basic information such as a title, a running time, and a file size, but the currently available image information may represent even a scene of certain content, which is viewed in a specific frame of the entire image. This is an extension of consumable information, meaning that the rich media service can also provide richer and extensible services by referring to several multimedia elements such as texts, audio, video, fonts, images and graphics, and also more various information, including data, resources, files, application programs, and services, and by utilizing them.

However, even though it is desired to provide a user with services using various information obtained through making references, the conventional rich media technology does not provide a method of referring to other resources, information, and services for providing a rich media content service, and of conducting information exchange. For example, when a terminal desires to compose the entire service using weather information provided from a program that offers weather information, the terminal now has no way to activate the weather program by referring to (or in connection with) a rich media service, and/or has no technology capable of acquiring desired specific information from a weather information file or a weather program and utilizing or consuming the acquired information.

Therefore, there is a need for a method and apparatus for providing a rich media service being adaptive to various situations of terminals and users, by utilizing more various information, including data, resources, files, application programs, and services, in connection with other services, files, information and/or data associated with rich media content.

### SUMMARY OF THE INVENTION

Therefore, the present invention is designed to address at least the above-mentioned problems and/or disadvantages and to provide at least the advantages described below. Accordingly, an aspect of the present invention provides a rich media service providing method and apparatus capable of utilizing various rich and extensible information by referring to various information, including data, resources, files, application programs and services associated with rich media service content.

Another aspect of the present invention provides a rich media service providing method and apparatus for providing a service that is adaptive to various service situations and conditions of terminals and users that receive a service having the same configuration.

In accordance with an aspect of the present invention, a method is provided for providing a received rich media service by a terminal. The method includes receiving and handling service content; searching for reference information using representation information of reference information to be used in the received service content; composing the received service content in a form that can be provided to a user, using the searched reference information; and outputting the composed service content through a user interface.

In accordance with another aspect of the present invention, a terminal apparatus is provided for providing a received rich media service. The terminal apparatus includes a decoder for receiving and decoding service content; a composer for searching for reference information using representation information of the reference information to be used in the service content output from the decoder, and for composing the received service content in a form that can be provided to a user, using the searched reference information; and a renderer for outputting the composed service content in audio or video.

In accordance with another aspect of the present invention, a transmission method is provided for transmitting a rich media service to a terminal. The transmission method includes creating service content including representation information by which reference information to be used in content to be serviced can be acquired; encoding the created service content; and transmitting the encoded service content to the terminal.

In accordance with another aspect of the present invention, a transmission apparatus is provided for transmitting a rich media service to a terminal. The transmission apparatus includes a content creator for creating service content including representation information by which reference information to be used in content to be serviced can be acquired; an encoder for encoding the created service content; and a content transmitter for transmitting the encoded service content to the terminal.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates an operation of a terminal receiving a rich media service according to the prior art;

FIG. 2 illustrates an operation of a terminal receiving a rich media service according to an embodiment of the present invention;

FIG. 3 illustrates an operation of a terminal receiving an SAF stream according to an embodiment of the present invention;

FIG. 4 illustrates an operation of defining a new event according to an embodiment of the present invention;

FIG. 5 is a block diagram of a transmitter according to an embodiment of the present invention; and

FIG. 6 is a block diagram of a receiver according to an embodiment of the present invention.

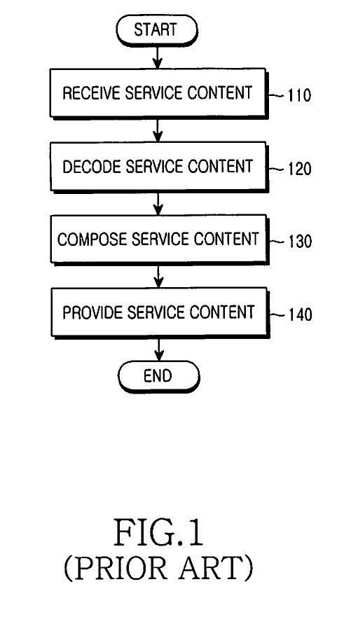

Throughout the drawings, the same drawing reference numerals will be understood to refer to the same elements, features and structures.

### DETAILED DESCRIPTION OF EMBODIMENTS OF THE INVENTION

The matters defined in the description such as a detailed construction and elements are provided to assist in a comprehensive understanding of embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The following embodiments of the present invention provide a method and apparatus in which a transmission side transmits rich media content with reference information related to various information, including data, resources, files, application programs, and services, and a terminal receives the rich media content and provides a richer and extensible rich media service through utilization and consumption of the various reference information.

The reference information includes all of data files expressed in various formats, which include rich media data as well as all types of data expressed in various information representation forms such as a binary data form and an Extensible Markup Language (XML) form, various media, data tracks in data files, data packets, data streams, and structuralized information aggregates. In the following description, a process of making reference to information includes all processes such as referencing, exchange, and reuse of reference information.

Further, in the following description, “representation information of the reference information” includes all of related information used to search for reference information for composing service content.

Although the embodiments of the present invention will be described in connection with a method in a terminal based on a Lightweight Application for Scene Representation (LASeR) engine among Rich Media Engines (RMEs), the LASeR engine is a merely provided as an example for a better understanding of the present invention, and the method based on the LASeR engine can be equally applied in other RME-base terminals. Of course, when the RME or system applied to the terminal is changed, the names and terminology associated with the LASeR engine will be changed to corresponding ones uniquely used in another RME or system.

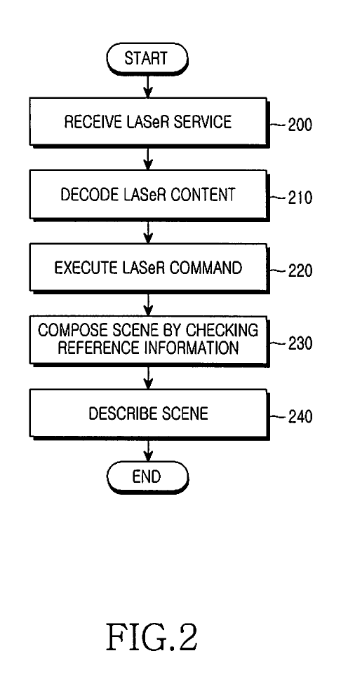

FIG. 2 illustrates an operation of a terminal receiving LASeR content according to an embodiment of the present invention.

Referring to FIG. 2, a terminal receives LASeR content in step 200, and decodes the received LASeR content in step 210. The LASeR content decoding process of step 210 may not be performed when the received LASeR content has not undergone an encoding process. In step 220, the terminal checks and executes a LASeR command in the decoded LASeR content. The LASeR command, which represents a change in scene in a descriptive way, includes a ‘NewScene’ element or a command to draw a new scene, an ‘Insert’ element or a command to insert an attribute, a ‘Select’ element or a command to delete an attribute, etc. Scene composition elements of the LASeR content include elements representing media and graphic objects in a descriptive way, attributes describing attributes of each element, events, and scripts. Because the LASeR content the terminal received includes reference information referring to various information, including data, resources, files, application programs, and services, which are needed to make the scene composition elements, the terminal analyzes representation information associated with reference information of the received LASeR content and searches for reference information to be utilized in the received LASeR content based on the analyzed information in step 230. Here, the reference information utilized in received service content can be a local resource located in the terminal, or an external resource located in another system or another program outside the terminal. The terminal composes the LASeR content in a form that can be provided to the user, using scene composition elements including the searched reference information. In step 240, the terminal outputs the composed LASeR content through a user interface supporting video and/or audio. Although not illustrated in the drawings, all events associated with the LASeR content may be performed before step 240.

A description will now be made of detailed examples of the method, which was described in step 230 of FIG. 2, for composing LASeR content using reference information referred to various information, including data, resources, files, application programs and services needed to compose the LASeR content.

In accordance with an embodiment of the present invention, a detailed description will made of a method for representing reference information referring to various information, including data, resources, files, application programs, and services for making scene composition elements constituting LASeR content, and of a method for newly creating and defining element and attribute information and composing a scene including the reference information using the elements, attributes, and attribute values.

The element is a basic unit of an object constituting a scene, the attribute is a characteristic of the element constituting the scene, and the attribute value is a detailed value of the attribute. In the case of a rectangle, for example, the element is ‘rect’ indicating the rectangle shape, the attribute is ‘width’ indicating a horizontal length of the rectangle, which is one example of a characteristic used to represent the rectangle, and the attribute value is ‘10’, which is a detailed value of the attribute ‘width’.

Table 2A below shows an example of data used to make scene composition elements constituting LASeR content, in which an Electronic Service Guide (ESG) used in a broadcast service is represented with data structuralized in the form of an Extensible Markup Language (XML). The XML, a markup language for describing a structure of data, is a language that defines a method of structuralizing specific information to describe the specific information. The XML can describe structuralized data by representing information in a hierarchical structure, and can indicate a reference relationship between various data. Data in the XML form can be structuralized in different manners for the same information, which generally makes it easy to analyze data in a program, or to share and exchange information with another program.

```
TABLE 2A
<!-- Electronic Service Guide : ESG.xml -->
<ESGMain xmlns=″urn:dvb:ipdc:esg:2005″ xmlns:mpeg7=″urn:mpeg:mpeg7:schema:2001″
xmlns:tva=″urn:tva:metadata:2005″ xmlns:xsi=″http://www.w3.org/2001/XMLSchema-
instance″>
  <ESG>
...
<PurchaseTable>
<Purchase start=”2006-04-12T13:00:00Z” end=”2006-04-18T23:00:00Z”
purchaseID=”dvbipdc://example.com/Purchase/12458584”>
  <ServiceBundleRef IDRef=”ServiceBundleId_A”/>
  <Price currency=”EUR”>15.0</Price>
  <Price currency=”USD”>21.0</Price>
  <UsageConstraints>
    <PurchaseType
href=”urn:tva:metadata:cs:PurchaseTypeCS:2004:playCounts”/>
    <QuantityUnit href=”urn:tva:metadata:cs:UnitTypeCS:2004:plays”/>
    <QuantityRange max=”2”/>
  </UsageConstraints>
  <UsageConstraints>
    <PurchaseType href=
urn:tva:metadata:cs:PurchaseTypeCS:2004:playForPeriod/>
    <QuantityUnit href= urn:tva:metadata:cs:UnitTypeCS:2004:day/>
    <QuantityRange max=”2”/>
  </UsageConstraints>
  <Description>This is the special offer for Easter</Description>
  <MediaTitle>
    <mpeg7:TitleImage>
      <mpeg7:MediaUri>EasterTitle.jpg</mpeg7:MediaUri>
    </mpeg7:TitleImage>
  </MediaTitle>
</Purchase>
</PurchaseTable>
...
</ESG>
</ESGMain>
```

Table 2B below shows an example of LASeR content that intends to use the ESG data as part of a scene composition element. In Table 2B, a scene (<svg> . . . </svg>) is included in a command ‘NewScene’, which indicates a drawing of a new scene, which is one of LASeR commands. ‘g’, which is one of scene composition elements, is included in the scene (<svg> . . . </svg>), and the ‘g’ element serves as a container capable of containing and representing various elements constituting the scene. In the example of Table 2B, as for the ‘g’, an attribute value of an ‘id’ attribute is ‘PurchaseTable’, and the ‘g’ includes ‘rect’, which is a scene composition element for drawing a rectangle, and ‘image’, which is a scene composition element for representing an image. In this way, various scene composition elements constituting rich media content, i.e., graphic elements, such as ‘rect’ for drawing a rectangle and ‘circle’ for drawing a circle, and various scene composition elements such as texts, audio, video and images, can be included in the ‘g’ element.

Table 2B below shows an example of LASeR content created using new attribute and attribute value information for referring to information for a rich media service as in step 240, in order to apply a method for utilizing reference information to the rich media technology according to an embodiment of the present invention.

TABLE 2B

```
<NewScene>
  <svg>
      ...
      <g id=”PurchaseTable”>
      <rect .../>
      <image id=”TitleImage” select=″...″ .../>
    </g>
    ...
  </svg>
</NewScene>
```

As in the example of Table 2B, a new attribute ‘select’ used for making references is newly defined to represent an actual image file of the ‘image’ element. In order to make reference to data in a specific location, it is possible to use a method of indicating a name of an image file as ‘a.jpg’, and/or indicating a location of the image file as ‘ . . . / . . . / . . . /a.jpg’, ‘http://www.laser.org/a.jpg’. However, it is not possible to make reference to data in a file or document such as the ESG in Table 2A. In order to make reference to data in such a specific file or document, a method has been defined that assigns an XML Path Language (XPath) for assigning an address to a node of a document in the XML form, and assigns an address for a range and string of a document by extending the XPath, in addition to a node. Another method has been defined that represents an attribute value of the new attribute ‘select’ using an XML Pointer Language (XPointer), for example, in order to indicate an address of desired data.

TABLE 3A

referencePointer ::= ‘reference’ ‘(‘ referenceData ‘)’

TABLE 3B

```
referencePointer ::= ‘reference’ ‘(‘ referenceData ‘)’
    | ‘xmlns’ ‘(‘ XPtrNsDecl? ’)’
    | Scheme ‘(‘ SchemeSpecificExpr ’)’
```

TABLE 3C

referencePointer ::= referenceName ‘(‘ referenceData ‘)’
referenceName ::= ‘reference’

By newly defining a structure of ‘reference( )’ for searching for reference information, as shown in Table 3A to Table 3C above, it is possible to make reference to data in the ESG of Table 2B.

As defined in Table 3B, identification information of data for identifying desired reference information, for example, a namespace of metadata, can be provided as information capable of identifying information to be referred to. In the examples of Table 3A to Table 3C, ‘referenceData’ can be represented using a syntax of Xpath and can also be represented with a syntax of Xpointer. That is, the ‘referenceData’ can be represented using various data representation methods and search methods for representing structural information.

If it is intended to designate an image file specified in a child node ‘mpeg7:MdiaUri’ of a child node ‘mpeg7:TiteImage’ of a node ‘MediaTitle’ in Table 2A as an actual image file of the ‘image’ element of Table 2B, then ‘select:ESG.xml#reference(ESGMain/ESG/PurchaseTable/Purchase/MediaTitle/mpeg7: TitleImage/mpeg7:MediaUri/text( ))’ can be represented. In this case, in the example of Table 2B, a detailed image file of ‘image’ becomes ‘EasterTitle.jpg’.

As another example, for an element already having an ‘xlin:href’ attribute for making references, such as ‘image’, ‘video’ and ‘audio’, it can be represented as ‘xlink:href’=ESG.xml#reference(ESGMain/ESG/PurchaseTable/Purchase/MediaTitle/mpeg7:TitleImage/mpeg7:MediaUri/text( ))’ by using ‘xlink:href’.

Table 4A and Table 4B below show examples of LASeR content created using new element and attribute information for making reference to information for a rich media service according to an embodiment of the present invention.

TABLE 4A

```
...
<Reference id=”reference_01”
match=” ESG.xml# reference(ESGMain/ESG/PurchaseTable)”
>
                ...
        <g id=”PurchaseTable”>
          <rect .../>
          <image  id=”TitleImage”  select=″Purchase/
MediaTitle/mpeg7:TitleImage/mpeg7:MediaUri/text( ))″  .../>
        </g>
...</Reference>...
```

```
TABLE 4B
...
<Reference id=”reference_01”
targetResource=”ESG.xml”
targetRoot=”ESGMain”
match=”#reference(ESGMain/ESG/PurchaseTable)”
>
...
        <g id=”PurchaseTable”>
          <rect .../>
          <image  id=”TitleImage”  select=″Purchase/MediaTitle/
mpeg7:TitleImage/mpeg7:MediaUri/text( ))″  .../>
        </g>
...
</Reference>
...
```

Referring to Table 4A and Table 4B, a new ‘Reference’ element for referring to information for a rich media service includes scene composition elements having a new attribute ‘select’ for making references. The new ‘reference’ element may include a Container element used to contain other elements among the elements constituting a scene, for example, may include other elements such as ‘svg’ and ‘g’. The ‘Reference’ element includes a new attribute ‘match’ indicating a reference entry point for referring to data in a specific location. An element having a ‘ref’ attribute among the elements included in the new ‘Reference’ element, i.e., located in a child node of the ‘Reference’ element, represents a path from a reference entry point represented by the ‘match’ attribute up to target data of data the element itself intends to make reference to, and represents a data structure or location. Reference entry points of all child elements having the ‘select’ attribute among the child elements of the ‘Reference’ element start at ‘match’.

For example, if the ‘Reference’ element for referring to data formed in structures of A/B/C/D has an attribute ‘match=A/B’, a child element of the ‘Reference’ element intending to make reference to C or D information has an attribute which is represented as ‘select’=‘C’ or ‘select’=‘C/D’. It can be considered that because the ‘select’=‘C’ has the same meaning as ‘select’=A/B/C’ and ‘select’=‘C/D’ has the same meaning as ‘select’=‘A/B/C/D’, they represent the same reference information. The ‘match’ attribute can be represented using a syntax of Xpath and can also be represented with a syntax of Xpointer. That is, the ‘match’ attribute can be represented using various data representation methods and search methods for representing structural information.

The ‘Reference’ element may further have an ‘xmlns’ attribute for identification information of a file or data containing reference information, a ‘targetResource’ attribute indicating a name of resources for making references, such as files, data or application programs for making references, or a ‘targetRoot’ attribute for representing a root that is the uppermost information of the reference information.

In the example of Table 4B, as to roles of respective attributes, a process of referring to target information referred to in an ‘ESG.xml’ file to be referred to by an ‘image’ element whose ‘id’ attribute value is ‘TitleImage’, includes checking a root node in the ‘ESG.xml’ file, which is an information aggregate including desired information, and if the root node is identical, referring to target information by searching for information starting from a reference entry point.

Table 5A and Table 5B below show other examples where attributes of the ‘Reference’ element are defined.

TABLE 5A

```
...
<Reference id=”reference_01” targetResource=”ESG.xml”
match=”PurchaseTable”>
...
        <g id=”PurchaseTable”>
          <rect .../>
          <image  id=”TitleImage”  select=″Purchase/
MediaTitle/mpeg7:TitleImage/mpeg7:MediaUri/text( ))″  .../>
        </g>
...
</Reference>
...
```

TABLE 5B

```
...
<Reference  id=”reference_01”  targetResource=”ESG.xml”
match=”PurchaseTable” depth=”2”>
...
        <g id=”PurchaseTable”>
          <rect .../>
          <image  id=”TitleImage”  select=″Purchase/
MediaTitle/mpeg7:TitleImage/mpeg7:MediaUri/text( ))″ .../>
        </g>
...
</Reference>
...
```

In the example of Table 5A, a method of representing a reference entry point represented by the ‘match’ attribute, represents a node itself or its information, in a location where making reference is to be started, instead of representing a path from the uppermost node of data to which its reference is actually made, up to target data as in Table 4A. Similarly, the ‘match’ attribute in Table 5A can be represented using a syntax of Xpath and can also be represented with a syntax of Xpointer. That is, the ‘match’ attribute can be represented using various data representation methods and search methods for representing structural information.

Referring to Table 5B, the ‘Reference’ element further includes depth information of a node in a tree, when depth information of the reference entry point information, for example, data to be referred to, is formed in a tree structure in a hierarchical structure of a data aggregate including reference entry point information described in the ‘match’ attribute. The reference entry point represented by the ‘match’ attribute can be found from nodes corresponding to a value of a ‘depth’ attribute. Another method checks a root node in the information aggregate by further using the ‘TargetRoot’ attribute, and then determines a location of a start node beginning from the root node using the depth information, if the root node is identical.

Assuming that a depth of the root node is 0, ‘Depth’ of AA is ‘2’, if a structure of the node is given as, for example, ‘root(uppermost node)/A/AA/AAA’.

Table 6 below shows an example of LASeR content created using new element and attribute providing a value of a specific part of the reference information.

```
TABLE 6
...
<g id=″ex02″>
  <circle ...>
    <animate .../>
  </circle>
  <text ...>
  PRICE : <value-of select=”ESG.xml#reference(SGMain/ESG/
PurchaseTable/Purchase[@purchaseID=″dvbipdc://example.com/
Purchase/12458584”]/
Price[@currency=″EUR″]/text( )” /> EUR
  <text>
</g>
...
```

Referring to Table 6, a new ‘value-of’ element containing a new ‘select’ attribute indicating a location of reference information is interposed between ‘PRICE:’ and ‘EUR’, which are element values of a ‘text’ element in the LASeR content. The ‘value-of’ element provides a value of specific reference information. In the example of the ESG in Table 2A. Because a value of “ESG.xml#reference(SGMain/ESG/PurchaseTable/Purchase[@purchaseID=“dvbipdc://example.com/Purchase/12458584”]/Price[@currency=“EUR”]/text( )” is ‘21.0’, the ‘text’ element in the scene is viewed as ‘PRICE: 21.0 EUR’. This element can be used as a child element of the ‘Reference’ element.

Table 7 below shows an example of LASeR content created using new element and attribute for representing the existing scene composition element and attribute information based on reference information.

TABLE 7

```
...
<g id=″ex02″>
  <circle ...>
    <animate .../>
  </circle>
  <text id=”color” ...>
  PRICE : <value-of select=”...” /> EUR
  </text>
</g>
...
<insertRef ref=”color” insertAttr=”fill”
select=”A.xml#reference(a/aa/aaa/text( )” />
...
```

Referring to Table 7, a new ‘insertRef’ element for representing the existing scene composition element and attribute information using reference information, includes a ‘ref’ attribute for referring to scene composition elements, an ‘InsetAttr’ attribute for representing an attribute value using reference information, or for changing and representing the existing attribute value, and a ‘select’ attribute for representing a location of the reference information. In this example, when an ‘A.xml#reference(a/aa/aaa/text( )’ value is ‘Blue’, the ‘insertRef’ element sets a ‘fill’ attribute of a ‘text’ element whose ‘id’ attribute value referred to by the element itself is ‘color’, as ‘blue’, which is obtained from the reference information.

Although only the attributes have been described in the above example, the elements can also be represented in the above method. As a result of the example, the same resultant scene is represented in every case, no matter whether the attribute value is represented as fill=‘blue’, represented as fill=“A.xml#reference(a/aa/aaa/text( )”, or represented as <text fill=“$color” . . . > <InsertRef id=“color” select=A.xml#reference(a/aa/aaa/text( )”> by referring to an ‘id’ attribute value of the ‘insertRef’ element by an element that intends to refer to information about the ‘insertRef’ element. This element can also be used as a child element of the ‘Reference’ element. Values of the respective elements of the present invention can be represented with Xpath, XPoint, or using various methods capable of representing location and path of reference information.

Locations, times, and paths by which a change in reference information can be checked, and reference information for checking the change can be further defined as a new attribute value for making references. When an attribute regarding the time for checking the change in reference information is added, rich media content can be composed by checking the change in information referred to at a predetermined time.

Another embodiment of the present invention defines a new field in which a header can previously provide basic information about metadata, data aggregates, or other services to be used or referred to in a desired rich media service. A terminal can acquire such a field before the content composition process of step 230 as illustrated in FIG. 2.

TABLE 8
<LASeRHeader ...
ReferredDataSet=”urn:mpeg:mpeg21:2003:01-DIA-NS
http://www.w3.org/1998/Math/MathML urn:mpeg:mpeg4:2003:BIFS”
/>

Referring to Table 8, a newly defined ‘ReferredDataSet’ field provides identification information for metadata, data aggregates or other services to be used, or referred to content in rich media content, or can provide acquired information. The identification information can be represented in various ways such as namespace, mimeType, content type, unique name of a data processing module, encoding type, data type, etc.

As illustrated in Table 9 below, a specific value can be previously designated for information about metadata, data aggregates, or other services. In this case, representation of <LASeRHeader ReferredDataSet=“0x01 0x08 . . . ” . . . /> is possible.

TABLE 9

| Value | Namespace |
|---|---|
| 0x01 | Urn:mpeg:mpeg4:2005:LASeR |
| 0x02~ | Reserved |

Identification information and root (uppermost node of a data aggregate) information of referred information can be notified as <LASeRHeader ReferredDataSet=“urn:mpeg:mpeg21:2003:01-DIA-NS(root)” . . . +>. Alternatively, detailed names of data files or information to be referred to can be notified as <LASeRHeader . . . . ReferredDataSet=“A.xml C.mp4”/>. Also, location information can also be provided together that can indicate update of <LASeRHeader ReferredDataSet=“A.xml(updateInfoLocation)”/> data. In ESG for example, the location information capable of indicating update of data can make it possible to refer to version information of the ESG to notify update of data, when the version information of the ESG is changed.

Another embodiment of the present invention provides a method for transmitting basic information about other services, files, information, or data associated with rich media content to be referred to, with a Simple Aggregation Format (SAF) data stream.

The SAF multiplexes and synchronizes an Elementary Stream (ES), and minimizes complexity requirements. Therefore, this technology provides free expression of various multimedia and interaction with users in portable terminals having a limited memory and/or power.

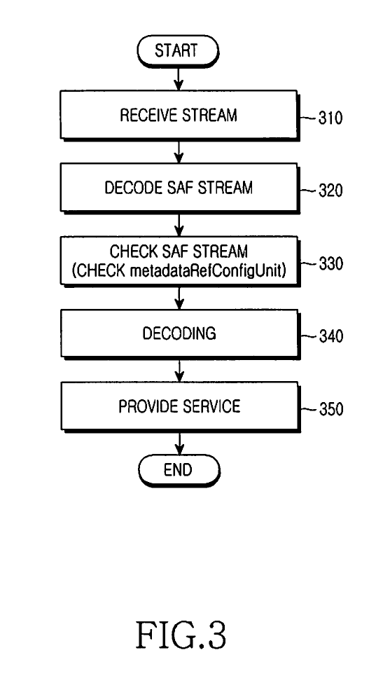

FIG. 3 illustrates an operation of a terminal according to an embodiment of the present invention.

Referring to FIG. 3, a terminal receives a service data stream in step 310, and decodes a SAF stream in step 320. In step 330, the terminal checks the decoded SAF stream by checking ‘Reference Configuration Unit (RefConfigUnit)’ information defined in accordance with an embodiment of the present invention. The terminal decodes data constituting service content in step 340, and outputs the decoded data in a service time through a user interface supporting video and/or audio in step 350. In a process of providing the service, an operation of searching for and selecting reference information referring to other services can be performed.

The ‘RefConfigUnit’ may further include the number of data aggregates and other services to be referred to in the provided rich media content, information capable of identifying the data aggregates and other services to be referred to, information for indicating a size of information to be referred to, names of the data aggregates to be referred to, information indicating whether to check update of the reference information in the data aggregates to be referred to, and information indicating a location where update of the reference information can be checked in the data or data aggregates to be referred to.

Another embodiment of the present invention provides a method for exchanging information in connection with other services capable of providing a service referring to rich media content, and a method for dynamically utilizing reference information. In the rich media data stream, information about management of network sessions, a decoding process, a change in a terminal's operation, or data input/output in an interface are examples of events. Upon sensing an event, a terminal may connect it to a change in scene for the event or a change in operation of the terminal.

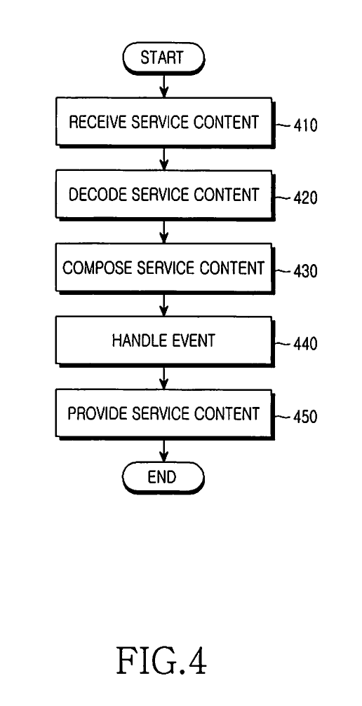

FIG. 4 illustrates an operation of a terminal for dynamically checking a change in reference information and dynamically using reference information according to an embodiment of the present invention.

Referring to FIG. 4, a terminal receives service content in step 410, and decodes the received service content in step 420. In step 430, the terminal composes the decoded service content in a form that can be provided to a user. In step 440, the terminal handles all events of the received content, and a new event, which is described in the present invention and defined by making reference to other services and application programs. In step 450, the terminal provides a service according to the handled new event.

In accordance with this embodiment of the present invention, a scenario is possible, in which an event is activated by a user's input while the user is receiving a service. For example, a new event may occur according to a user's input. That is, it is also possible to handle events occurring after step 440. Handling the new event is equivalent to executing a command for dynamically utilizing reference information.

Tables 10A and 10B below show an example of defining a new event for referring to and activating other services and application programs, in accordance with an embodiment of the present invention, as handled in step 440. As will be described in the following example, it is possible to perform a specific operation by recognizing a change in external reference information or program, and to perform an operating process of previously designating information or program to be referred to, and then referring to the designated information or program.

TABLE 10A

| Event name | Namespace | Description |
|---|---|---|
| ApplicationActivated | Urn:mpeg:mpeg4:laser:2008 | External |
| | | application is |
| | | activated when |
| | | event occurs. |

TABLE 10B

| Event name | Namespace | Description |
|---|---|---|
| ApplicationActivated(targetApplication) | urn:mpeg:mpeg4:laser:2008 | External application is |
| | | activated when event occurs. |

Table 11A and Table 11B below show an example where the new event is defined in an Interface Definition Language (IDL)

TABLE 11A

```
Interface ApplicationActivatedEvent : LASeREvent {
    Readonly attribute DOMString targetApplication;
    Readonly attribute Boolean availableApplication;
}
```

TABLE 11B

```
Interface ApplicationActivatedEvent : LASeREvent {
    Readonly attribute DOMString targetApplication;;
    Readonly attribute Boolean availableApplication;
    Readonly attribute Boolean checkUpdate;
    Readonly attribute DOMString UpdateLocation;
}
```

In Table 11A and Table 11B, ‘ApplicationActivatedEvent’ can have identification information as an input value. The input value can have a string form or a URI form, and can be represented by XPath and XPoint. Using the defined interface, it is possible to check reference information (targetApplication) of target data or program to be referred to, reference information (availableApplication) of available data or program to be referred to, update information (checkUpdate) of reference information to be referred to, and an acquisition location (updateLocation) of updated reference information. An event type of the ‘ApplicationActivatedEvent’ interface can be the event defined in Table 11A and Table 11B. Any attribute of the ‘ApplicationActivatedEvent’ interface will be possible as long as it can represent information about a service or an application program to be activated. Each event can be an event activated to use other services, files, information or data, and can also be used as an event for detecting a change or variation in the reference information by referring to specific service, file, information or data.

For example, when an event occurrence condition is defined to refer to version information so as to determine a change in version information of specific data, it is possible to check information about a location referred to by a pertinent event during scene composition and then enable the event to occur, if the version information is changed.

Another embodiment of the present invention provides a detailed method for exchanging information in connection with other services capable of providing a service referring to rich media content.

Table 12A to Table 12C below show an example where new ApplicationActivated element and attribute are defined to exchange information in connection with other services that can provide a service referring to rich media content. The ApplicationActivated element may include unique identification information of a pertinent service or application program, for example, ‘classid’ representing identification information such as a MAC address of an information device, ‘put_value_type’ representing a type of an input information value, ‘put_value’ representing a value of input information, and ‘xlink:href’ representing service composition elements that refer to or use a return value that is extracted or received from the pertinent service or application program. An operation of the ApplicationActivated element makes it possible to activate a service or application program to be used using ‘classid’, transmit input information with the application program, receive a return value from the application program, and utilize or use the received return value for the service by the service composition elements.

TABLE 12A

<ApplicationActivated id=”Clock” classid=”....”
put_value _type=”... “ put_value=”...”
xlink:href=”...“/>

Table 12B below shows an example where there are a plurality of input values to a pertinent application program.

TABLE 12B

```
<ApplicationActivated id=”Clock” classid=”...” xlink:href=”...“>
    <Put put_value_type=”... “ put_value=”...” />
    <Put put_value_type=”... “ put_value=”...” />
    <Put put_value_type=”... “ put_value=”...” />
    <Put put_value_type=”... “ put_value=”#A” />
</ApplicationActivated>
```

Table 12C below shows an example where there are a plurality of input values to a pertinent application program and a type of a return value to be received from the application program is previously designated.

TABLE 12C

```
<ApplicationActivated id=”Clock” classid=”....”
Return_value_type=”...” xlink:href=”...“>
    <Put put_value_type=”... “ put_value=”...” />
    <Put put_value_type=”... “ put_value=”...” />
    <Put put_value_type=”... “ put_value=”...” />
</ApplicationActivated>
```

In accordance with an embodiment of the present invention, for the input values or return values, Value_Type can be previously designated as a specific value as illustrated in Table 13 below.

TABLE 13

| Value | value_Type |
|---|---|
| 0x01 | String |
| 0x02 | integer |
| 0x03 | unit |
| 0x04 | anyURI |
| 0x05 | nmtoken |
| 0x06 | idRef |
| 0x07~ | Reserved |

Of course, when the elements and attributes have the same meanings in the foregoing embodiments, the names of the elements and attributes or attribute values are exchangeable with others.

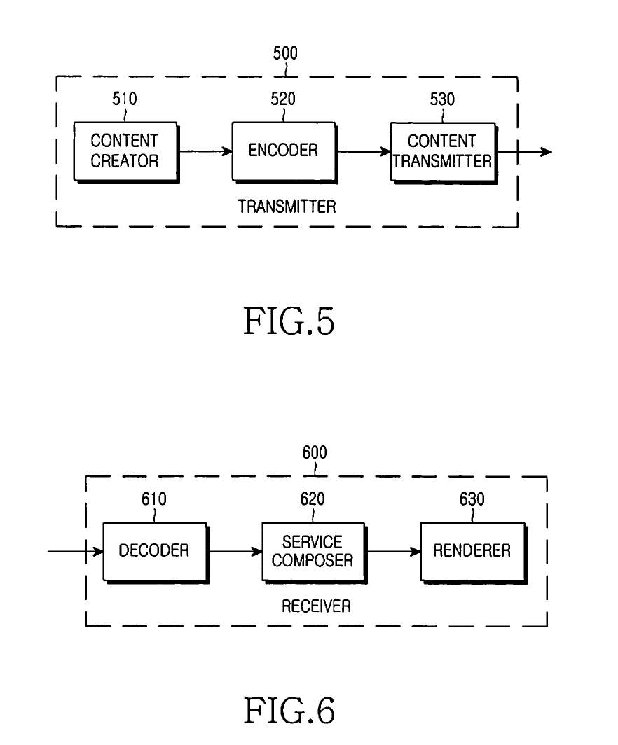

FIG. 5 is a block diagram illustrating a transmitter 500 according to an embodiment of the present invention.

Referring to FIG. 5, a LASeR content creator 510 creates content including events, service composition elements, attributes, etc., for providing a service by referring to new elements and attributes and other services or application programs, which provide information for referring to other services, files, information or data associated with rich media content, which are described above in the embodiments of the present invention. Further, the content creator 510 creates content of an operation by event occurrence when creating scene composition elements.

An encoder 520 encodes the content received from the content creator 500, and provides the encoded content to a content transmitter 530. The content transmitter 530 transmits the provided encoded content to a receiver.

FIG. 6 is a block diagram illustrating a receiver 600 according to an embodiment of the present invention.

Referring to FIG. 6, a decoder 610 receives content from a transmitter, decodes the received content and delivers the decoded content to a service composer 620. The service composer 620 receives the decoded data, and checks content including composition elements and attributes for providing a service referring to new elements and attributes and other services or application programs that provide information for referring to other services, files, information or data associated with the rich media content, which are described above in the embodiments of the present invention. The service composer 620 also checks content of an operation by use of events or event occurrence. That is, the service composer 620 plays a role of controlling scene composition to compose the scene. A renderer 630 provides a service of, for example, displaying content on a terminal using the checked information.

As is apparent from the foregoing description, according to the various embodiments of the present invention, the rich media service also refers to and utilizes several multimedia elements such as texts, audio, video, fonts, images and graphics, and also various information, including data, resources, files, application programs and services, thereby extending a range of information consumable as part of rich media content and thus providing richer and extensible services.

In addition, the embodiments of the present invention provide services that are adaptive to various service situations and conditions of terminals and users that receive services having the same configuration.

The above-described embodiments of the present invention can also be embodied as computer-readable codes on a computer-readable recording medium. The computer-readable recording medium is any data storage device that can store data that can thereafter be read by a computer system. Examples of the computer-readable recording medium include, but are not limited to, Read-Only Memory (ROM), Random-Access Memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for providing a received rich media service by a terminal including a decoder, a composer, and a renderer, comprising:
receiving and decoding, by the decoder, service content;
searching, by the composer, for reference information using representation information of the reference information in the received service content, and composing the received service content in a form that can be provided to a user, using the searched reference information; and
outputting, by the renderer, the composed service content through a user interface.

2. The method of claim 1, wherein the reference information includes at least one of data, a resource, a file, an application program, and a service, which are used to make a scene composition element constituting the service content.

3. The method of claim 1, wherein the reference information includes a local resource located in the terminal or an external resource located outside the terminal.

4. The method of claim 1, wherein the reference information includes information associated with a scene composition element constituting the service content or an attribute of the scene composition element.

5. The method of claim 1, wherein the representation information of the reference information includes at least one of identification information, locations, paths, data structures, and changed times of the reference information.

6. The method of claim 1, wherein composing the service content comprises:
analyzing an element and an attribute defined for information associated with the reference information included in the service content; and
searching for the reference information based on an analysis result.

7. The method of claim 1, wherein composing the service content comprises:
analyzing information associated with reference information transmitted in a header; and
searching for the reference information based on an analysis result.

8. The method of claim 1, wherein the representation information of the reference information is provided in a formatted data stream.

9. The method of claim 1, further comprising handling an event associated with the received service content or a new event defined by making reference to another service or application program.

10. The method of claim 1, further comprising exchanging information in connection with another service that provides a service referring to the service content.

11. A terminal apparatus for providing a received rich media service, comprising:
a decoder for receiving and decoding service content;
a composer for searching for reference information using representation information of the reference information in the service content, and for composing the received service content in a form that can be provided to a user, using the searched reference information; and
a renderer for outputting the composed service content to the user.

12. The terminal apparatus of claim 11, wherein the reference information comprises at least one of:
data;
a resource;
a file;
an application program; and
a service,
each of which is used to compose a scene composition element constituting the service content.

13. The terminal apparatus of claim 11, wherein the reference information comprises a local resource located in the terminal or an external resource located outside the terminal.

14. The terminal apparatus of claim 11, wherein the reference information comprises information associated with a scene composition element constituting the service content or an attribute of the scene composition element.

15. The terminal apparatus of claim 11, wherein the representation information of the reference information comprises at least one of:
identification information of the reference information;
locations of the reference information;
paths of the reference information;
data structures of the reference information; and
changed times of the reference information.

16. The terminal apparatus of claim 11, wherein the composer analyzes an element and an attribute defined for information associated with the reference information included in the service content, and searches for the reference information based on an analysis result.

17. The terminal apparatus of claim 11, wherein the composer analyzes information associated with the reference information transmitted in a header, and searches for the reference information based on an analysis result.

18. The terminal apparatus of claim 11, wherein the representation information of reference information is provided in a formatted data stream.

19. The terminal apparatus of claim 11, wherein the composer handles an event associated with the received service content or a new event given by making reference to another service or application program.

20. The terminal apparatus of claim 11, wherein the composer exchanges information in connection with another service that provides a service referring to the service content.

21. A transmission method for transmitting a rich media service to a terminal including a content creator, an encoder, and a content transmitter, comprising:
creating, by the content creator, service content including representation information from which reference information can be acquired;
encoding, by the encoder, the created service content; and
transmitting, by the content transmitter, the encoded service content to the terminal.

22. A transmission apparatus for transmitting a rich media service to a terminal, comprising:
a content creator for creating service content including representation information from which reference information can be acquired;
an encoder for encoding the created service content; and
a content transmitter for transmitting the encoded service content to the terminal.
